(19) United States
(12) Patent Application Publication
(10) Pub. No.: US 2015/0155536 A1
(43) Pub. Date: Jun. 4, 2015

(54) METHOD FOR PRODUCING SEPARATOR FOR NONAQUEOUS ELECTROLYTE SECONDARY BATTERIES

(71) Applicant: SUMITOMO CHEMICAL COMPANY, LIMITED, Chuo-ku, Tokyo (JP)

(72) Inventor: Junji Suzuki, Niihama-shi (JP)

(73) Assignee: SUMITOMO CHEMICAL COMPANY, LIMITED, Chuo-ku, Tokyo (JP)

(21) Appl. No.: 14/399,078

(22) PCT Filed: May 20, 2013
(86) PCT No.: PCT/JP2013/064554

§ 371 Date: Nov. 5, 2014

(30) Foreign Application Priority Data
May 24, 2012 (JP) 2012-118288

(51) Int. Cl. H01M 2/14; H01M 2/16

(52) U.S. Cl. CPC H01M 2/145; H01M 2/1686; H01M 2/166; H01M 10/052

(57) ABSTRACT

The present invention provides a method for producing a separator for a non-aqueous electrolyte secondary battery, wherein the method comprises the following steps (1) and (2). The use of this method makes it possible to obtain a separator having excellent heat resistance. A method for producing a separator for a non-aqueous electrolyte secondary battery, the method comprising:
(1) a step of applying a binder resin composition comprising a resin having a group represented by the following formula (I) and a solvent to a porous membrane of polyolefin; and
(2) a step of irradiating the applied composition with ultraviolet rays to form a composition layer.

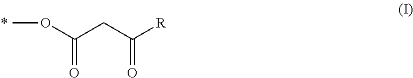

wherein R represents an alkyl group having 1 to 6 carbon atoms, and a symbol * represents a bonding hand.

### TECHNICAL FIELD

The present invention relates to a method for producing a separator for a non-aqueous electrolyte secondary battery.

### BACKGROUND ART

There has been known a method for producing a separator for a non-aqueous electrolyte secondary battery comprising a step of applying a binder resin composition containing polyvinyl alcohol and a solvent to a porous membrane of polyolefin (Patent Document 1).

### PRIOR ART DOCUMENTS

### Patent Document

Patent Document 1: WO 2008/093575

### DISCLOSURE OF THE INVENTION

However, a separator for a non-aqueous electrolyte secondary battery, which is obtained by using the production method, does not necessarily have adequately satisfactory heat resistance. It is an object of the present invention to provide a separator for a non-aqueous electrolyte secondary battery having excellent heat resistance.

The present invention includes the inventions described in [1] to [8] below.

[1] A method for producing a separator for a non-aqueous electrolyte secondary battery, the method comprising the following steps (1) and (2).
(1) a step of applying a binder resin composition comprising a resin having a group represented by the following formula (I) and a solvent to a porous membrane of polyolefin; and
(2) a step of irradiating the applied composition with ultraviolet rays to form a composition layer.

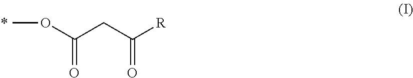

wherein R represents an alkyl group having 1 to 6 carbon atoms, and a symbol * represents a bonding hand.
[2] The production method according to [1], wherein the binder resin composition in the step (1) further comprises filler particles.
[3] The production method according to [2], wherein the filler particles are alumina particles.
[4] The production method according to any one of [1] to [3], wherein the resin having a group represented by the formula (I) is a resin having a structural unit represented by a formula (II).

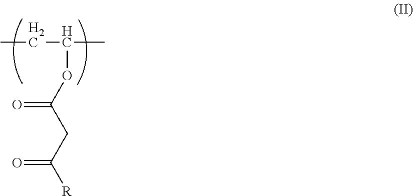

wherein R represents an alkyl group having 1 to 6 carbon atoms.
[5] The production method according to any one of [1] to [3], wherein the resin having a group represented by the formula (I) is a modified polyvinyl alcohol having a group represented by the formula (I).
[6] The production method according to any one of [1] to [5], further comprising:
(3) a step of drying the composition layer.
[7] A separator for a non-aqueous electrolyte secondary battery obtained by the production method according to any one of [1] to [6].
[8] A non-aqueous electrolyte secondary battery comprising the separator according to [7].

In accordance with the present invention, a separator for a non-aqueous electrolyte secondary battery having excellent heat resistance can be produced.

Hereinafter, the present invention will be described in detail.

### <Binder Resin Composition>

The binder resin composition used in the present invention contains a resin (may be referred to as a “binder resin” herein) having a group represented by the formula (I) (may be referred to as a “group (I)” herein) and a solvent. The binder resin composition preferably further contains filler particles.

### (Binder Resin)

Examples of the alkyl group having 1 to 6 carbon atoms represented by R in the formulas (I) and (II) include a methyl group, an ethyl group, a propyl group, an isopropyl group, a butyl group, a tert-butyl group, a pentyl group, and a hexyl group, and among these groups, a methyl group (the group (I) is an acetoacetyl group) is preferred.

The binder resin can be synthesized by, for example, a method of copolymerizing a monomer having the group (I) with another monomer. Specific examples of the monomer having the group (I) include acetoacetoxyethyl methacrylate, 4-vinylacetoacetanilide, and acetoacetyl allylamide. Further, the binder resin may be prepared by introducing the group (I) by a polymer reaction, and for example, the group (I) can be introduced by, for example, the reaction of a hydroxy group with diketene.

The content of the group (I) per 100 parts by weight of the binder resin is preferably 1 to 90 parts by weight, and more preferably 2 to 80 parts by weight.

Specific examples of the binder resin include an acetoacetyl-modified polyvinyl alcohol, an acetoacetyl-modified cellulose derivative, and acetoacetyl-modified starch. As the binder resin, a resin having a structural unit represented by the formula (II) above is preferred, a modified polyvinyl alcohol having the group (I) is more preferred, and an acetoacetyl-modified polyvinyl alcohol is moreover preferred.

The acetoacetyl-modified polyvinyl alcohol can be produced by a known method such as a reaction of polyvinyl alcohol with diketene. The degree of acetoacetylation of the binder resin is preferably 0.1 to 20% by mole, and more preferably 1 to 15% by mole. The degree of saponification is preferably 80% by mole or more, and more preferably 85% by mole or more. The degree of polymerization is preferably 500 to 5000, and more preferably 1000 to 4500.

### (Solvent)

Examples of the solvent include water and an oxygen-containing organic compound having a boiling point of 50 to 350° C. at normal pressures. Specific examples of the oxygen-containing organic compounds include compounds having an alcoholic hydroxyl group such as methanol, ethanol, n-propyl alcohol, isopropyl alcohol, n-butyl alcohol, isobutyl alcohol, s-butyl alcohol, amyl alcohol, isoamyl alcohol, methyl isobutyl carbinol, 2-ethylbutanol, 2-ethylhexanol, cyclohexanol, furfuryl alcohol, tetrahydrofurfuryl alcohol, ethylene glycol, hexylene glycol and glycerin; saturated aliphatic ether compounds such as propyl ether, isopropyl ether, butyl ether, isobutyl ether, n-amyl ether, isoamyl ether, methylbutyl ether, methyl isobutyl ether, methyl n-amyl ether, methylisoamyl ether, ethyl propyl ether, ethyl isopropyl ether, ethyl butyl ether, ethyl isobutyl ether, ethyl n-amyl ether and ethylisoamyl ether; unsaturated aliphatic ether compounds such as allyl ether and ethyl allyl ether; aromatic ether compounds such as anisole, phenetole, phenyl ether and benzyl ether; cyclic ether compounds such as tetrahydrofuran, tetrahydropyran and dioxane; ethylene glycol ether compounds such as ethylene glycol monomethyl ether, ethylene glycol monoethyl ether, ethylene glycol monobutyl ether, diethylene glycol monomethyl ether, diethylene glycol monoethyl ether and diethylene glycol monobutyl ether; monocarboxylic acid compounds such as formic acid, acetic acid, acetic acid anhydride, acrylic acid, citric acid, propionic acid and butyric acid; organic acid ester compounds such as butyl formate, amyl formate, propyl acetate, isopropyl acetate, butyl acetate, sec-butyl acetate, amyl acetate, isoamyl acetate, 2-ethyl hexyl acetate, cyclohexyl acetate, butylcyclohexyl acetate, ethyl propionate, butyl propionate, amyl propionate, butyl butyrate, diethyl carbonate, diethyl oxalate, methyl lactate, ethyl lactate, butyl lactate and triethyl phosphate; ketone compounds such as acetone, ethyl ketone, propyl ketone, butyl ketone, methyl isopropyl ketone, methyl isobutyl ketone, diisobutyl ketone, acetylacetone, diacetone alcohol, cyclohexanone, cyclopentanone, methylcyclohexanone and cycloheptanone; dicarboxylic acid compounds such as succinic acid, glutaric acid, adipic acid, undecanedioic acid, pyruvic acid and citraconic acid; and other oxygen-containing organic compounds such as 1,4-dioxane, furfural and N-methyl pyrrolidone.

A solvent obtained by mixing water and the oxygen-containing organic compound may be used. A preferred mixing ratio of the oxygen-containing organic compound to 100 parts by weight of water is 0.1 to 100 parts by weight, more preferably 0.5 to 50 parts by weight, and moreover preferably 1 to 20 parts by weight.

The amount of the solvent to be used is not particularly limited and may be such an amount that a property, in which the application to a porous membrane of polyolefin which will be described later is easy, can be obtained. The solvent is mixed so that the amount of the solvent is preferably 1 to 1000 parts by weight, more preferably 2 to 500 parts by weight, further preferably 3 to 300 parts by weight, and moreover preferably 5 to 200 parts by weight with respect to 1 part by weight of the binder resin.

### (Filler Particles)

As the filler particles, an inorganic material or an organic material is used. Examples of the inorganic material include calcium carbonate, talc, clay, kaolin, silica, hydrotalcite, diatom earth, magnesium carbonate, barium carbonate, calcium sulfate, magnesium sulfate, barium sulfate, aluminum hydroxide, magnesium hydroxide, calcium oxide, magnesium oxide, titanium oxide, alumina, mica, zeolite and glass. Examples of the organic material include homopolymer or copolymer of two or more kinds of styrene, vinyl ketone, acrylonitrile, methyl methacrylate, ethyl methacrylate, glycidyl methacrylate, glycidyl acrylate and methyl acrylate; fluororesins such as polytetrafluoroethylene, tetrafluoroethylene-hexafluoropropylene copolymer, tetrafluoroethylene-ethylene copolymer and polyvinylidene fluoride; melamine resin; urea resin; polyethylene; polypropylene; and polymethacrylate. Two or more kinds of particles may be mixed, or the same kind of particles having different particle size distributions may be mixed for using as the filler particles. As the material of the filler particle, alumina particles are preferred among these materials. The filler particles have an average particle size of preferably 3 μm or less, and more preferably 1 μm or less. The average particle size referred to herein is an average of primary particle diameters determined by SEM (scanning electron microscope) observation.

When the filler particles are used, the amount thereof to be used is preferably 1 to 1000 parts by weight, and more preferably 10 to 100 parts by weight with respect to 1 part by weight of the binder resin. When the amount of the filler particles to be used is too large, there is a possibility that the dimension stability of the resulting separator is deteriorated.

### (Other Components)

The binder resin composition used in the present invention may contain a curing agent, a dispersant, a plasticizer, a surfactant, a pH adjuster, an inorganic salt or the like within a range which does not impair the object of the present invention.

Examples of the curing agent include aldehyde compounds such as formaldehyde, glyoxal and glutaraldehyde; ketone compounds such as diacetyl and chloropentanedione; bis-(2-chloroethyl urea), 2-hydroxy-4,6-dichloro-1,3,5-triazine and compounds having a reactive halogen as described in U.S. Pat. No. 3,288,775; divinylsulfon and compounds having a reactive olefin as described in U.S. Pat. No. 3,635,718; N-methylol compounds as described in U.S. Pat. No. 2,732,316; isocyanato compounds as described in U.S. Pat. No. 3,103,437; aziridine compounds as described in U.S. Pat. No. 3,017,280 or U.S. Pat. No. 2,983,611; carbodiimide compounds as described in U.S. Pat. No. 3,100,704; epoxy compounds as described in U.S. Pat. No. 3,091,537; halogen carboxyaldehyde compounds such as mucochloric acid; dioxane derivatives such as dihydroxydioxane; and inorganic crosslinking agents such as chromium alum, zirconium sulfate, boric acid, borate and borax; and the like.

As the surfactant, a surfactant capable of improving the wettability for the porous membrane of polyolefin is preferred, and examples thereof include NOPCO WET (registered trademark) 50 and SN wet 366 (both manufactured by SAN NOPCO LTD.).

### <Separator for Non-Aqueous Electrolyte Secondary Battery (May be Referred to as a “Separator” Herein)>

The method for producing a separator of the present invention comprises:

(1) a step of applying the binder resin composition to a porous membrane of polyolefin; and
(2) a step of irradiating the applied composition with ultraviolet rays to form a composition layer. Moreover, the method for producing a separator of the present invention preferably comprises (3) a step of drying the composition layer.

The porous membrane of polyolefin more preferably contains a high molecular weight component having a weight average molecular weight of 5×10⁵ to 15×10⁶. Examples of the polyolefin include homopolymers or copolymers of ethylene, propylene, 1-butene, 4-methyl-1-pentene and 1-hexene. Among these, a copolymer predominantly comprising ethylene or a homopolymer of ethylene is preferred, and a homopolymer of ethylene, namely polyethylene, is more preferred.

The porous membrane of polyolefin has a porosity of preferably 30 to 80% by volume, and more preferably 40 to 70% by volume. When the porosity is less than 30% by volume, the amount of the electrolyte to be retained may be small, and when the porosity is more than 80% by volume, it may be insufficient to make a porous separator nonporous at high temperatures at which shutdown occurs. A pore size is preferably 3 μm or less, and more preferably 1 μm or less.

The thickness of the porous membrane of polyolefin is preferably 5 to 50 μm, and more preferably 5 to 30 μm. When the thickness is less than 5 μm, the shutdown characteristics (a porous separator becomes nonporous at high temperatures) of the separator may be insufficient, and when the thickness is more than 50 μm, since the thickness of the whole separator of the present invention is large, the electric capacitance of a battery may be reduced.

For such a porous membrane of polyolefin, a commercialized product having the above-mentioned characteristics can be used. Further, a production method for the porous membrane of polyolefin is not particularly limited, and any known method can be employed. Examples of the production method include a method in which a plasticizer is added to polyolefin and the resulting mixture is formed into a film, and then the plasticizer is removed by using an appropriate solvent, as shown in JP-A-H07-29563, and a method in which a structurally weak amorphous portion of a film comprising polyolefin is selectively stretched to form a fine pore, as shown in JP-A-H07-304110. The porous membrane of polyolefin may be previously subjected to a corona treatment before the binder resin composition is applied to the porous membrane.

A method for applying the binder resin composition to the surface of the porous membrane of polyolefin can be carried out by a method industrially usually performed such as application by a coater (also referred to as a doctor blade) or application by brush coating. The thickness of the composition layer can be controlled by adjusting the thickness of an applied film, the concentration of the binder resin in the binder resin composition, a ratio between the amounts of the filler particles and the binder resin, and the like.

As a light source of ultraviolet irradiation, ultraviolet lamps such as a low-pressure mercury lamp, a high-pressure mercury lamp and a metal halide lamp can be preferably employed.

With respect to the timing of ultraviolet irradiation, it is favorable to carry out ultraviolet irradiation before the density of the binder resin becomes high, that is, before all the solvent is removed, in order to have high water resistance. Specifically, the timing is prior to losing the fluidity of the applied composition and roughly coincides with the timing prior to starting the falling rate drying. Further, the timing prior to starting the drying is also one of favorable options from the viewpoint of prevention of wind ripple due to a drying air stream. An irradiation amount may be appropriately adjusted since the amount varies depending on irradiation spectrum of ultraviolet lamp, the degree of acetoacetylation of polymer, and the like.

The phrase “drying of a composition layer” in the present invention means that a solvent mainly contained in the composition layer is removed. Such drying is carried out, for example, by evaporating the solvent from the composition layer by heating means using a heating device such as a hot plate or depressurizing means using a depressurizing device, or combined means thereof. The conditions of the heating means or the depressurizing means can be appropriately selected within a range which does not largely deteriorate the air permeability of the porous membrane of polyolefin according to the kind of the solvent, and the like. For example, in the case of a hot plate, the surface temperature of the hot plate is preferably set to temperatures equal to or lower than the melting point of the porous membrane of polyolefin. Further, in the depressurizing means, a laminate of the composition layer and the porous membrane of polyolefin may be put in an appropriate depressurizing machine and the internal pressure of the depressurizing machine may be reduced to about 1 to 1.0×10⁵ Pa.

The thickness of the composition layer is preferably 0.1 μm to 10 μm or less. When the thickness is less than 5 μm, it may be insufficient to make a porous separator nonporous at high temperatures at which shutdown occurs, and when the thickness is more than 10 μm, the load characteristics of the resulting non-aqueous electrolyte secondary battery may be deteriorated.

The separator obtained by the production method of the present invention may include porous membrane layers, for example, an adhesion layer, a protective layer and the like other than the porous membrane of polyolefin and the composition layer within a range which does not impair the performance of the resulting non-aqueous electrolyte secondary battery.

The separator obtained by the production method of the present invention has a value of air permeability of preferably 50 to 2000 seconds/100 cc, and more preferably 50 to 1000 seconds/100 cc. When the value of air permeability is lower, it is preferred since the load characteristics of the resulting non-aqueous electrolyte secondary battery is more improved; however, when the value of air permeability is lower than 50 seconds/100 cc, it may be insufficient to make a porous separator nonporous at high temperatures at which shutdown occurs. When the value of air permeability is higher than 2000 seconds/100 cc, the load characteristics of the resulting non-aqueous electrolyte secondary battery may be deteriorated.

### <Non-Aqueous Electrolyte Secondary Battery (Hereinafter, May be Referred to as a “Battery”)>

The battery of the present invention includes the separator of the present invention. Hereinafter, components other than the separator of the present invention will be described with reference to the case where the battery of the present invention is a lithium ion secondary battery; however, the present invention is not limited to this example.

A lithium ion secondary battery includes, for example, electrodes (positive electrode and negative electrode), an electrolyte and a separator, and is a battery in which oxidation/reduction of lithium are performed at both the positive electrode and the negative electrode to store or release electrical energy.

### (Electrode)

The electrode includes a positive electrode and a negative electrode for a secondary battery. The electrode generally has a state in which an electrode active material and, if necessary, a conductive material are applied to at least one surface (preferably both surfaces) of a current collector through a binding agent.

As the electrode active material, an active material capable of absorbing and releasing lithium ions is preferably used. The electrode active material includes a positive electrode active material and a negative electrode active material.

Examples of the positive electrode active material include composite metal oxides, particularly composite metal oxides containing at least one metal of lithium, iron, cobalt, nickel and manganese, and preferred examples thereof include active materials containing LiₓMO₂ (wherein M represents one or more kinds of transition metals and preferably represents at least one of Co, Mn and Ni, and 1.10>x>0.05), or Li₇M₂O₄ (wherein M represents one or more kinds of transition metals and preferably represents Mn, and 1.10>x>0.05), for example, composite oxides represented by LiCoO₂, LiNiO₂, (wherein 1.10>x>0.05, 1>y>0) or LiMn₂O₄.

Examples of the negative electrode active material include various silicon oxides (SiO₂, etc.), carbonaceous materials, and metal composite oxides, and preferred examples thereof include carbonaceous materials such as amorphous carbon, graphite, natural graphite, MCMB, pitch-based carbon fiber and polyacene; composite metal oxides represented by AₓM_{y}O_{z} (wherein A represents Li, M represents at least one selected from Co, Al, Sn and Mn, O represents an oxygen atom, and x, y, and z are respectively numbers satisfying the ranges of 1.10≧x≧0.05, 4.00≧y≧0.85, 5.00≧z≧1.5) and other metal oxides.

Examples of the conductive material include conductive carbons such as graphite, carbon black, acetylene black, Ketjen black and activated carbon; graphite conductive materials such as natural graphite, thermally expansible graphite, scaly graphite and expansible graphite; carbon fibers such as vapor-grown carbon fibers; metal fine particles or metal fibers such as aluminum, nickel, copper, silver, gold or platinum; conductive metal oxides such as ruthenium oxide and titanium oxide; and conductive polymers such as polyaniline, polypyrrole, polythiophene, polyacetylene and polyacene.

Carbon black, acetylene black, and Ketjen black are preferred in that the conductivity is effectively improved at a low amount.

The content of the conductive material is, for example, preferably 0 to 50 parts by weight, and more preferably 0 to 30 parts by weight with respect to 100 parts by weight of the electrode active material.

Examples of the material of the current collector include metals such as nickel, aluminum, titanium, copper, gold, silver, platinum, aluminum alloy and stainless steel; carbon materials or activated carbon fibers coated with nickel, aluminum, zinc, copper, tin, lead or alloys thereof by plasma spraying or arc spraying; and conductive films formed by dispersing a conductive material in rubber or resin such as styrene-ethylene-butylene-styrene (SEBS) copolymer.

Examples of the form of the current collector include a foil, a flat plate, a mesh form, a net form, a lath form, a punched form, an embossed form, and the form of combination thereof (e.g., meshed flat plate).

A surface of the current collector may be etched to form projections and depressions.

Examples of the binding agent include fluorinated polymers such as polyvinylidene fluoride; diene polymers such as polybutadiene, polyisoprene, isoprene-isobutylene copolymer, natural rubber, styrene-1,3-butadiene copolymer, styrene-isoprene copolymer, 1,3-butadiene-isoprene-acrylonitrile copolymer, styrene-1,3-butadiene-isoprene copolymer, 1,3-butadiene-acrylonitrile copolymer, styrene-acrylonitrile-1,3-butadiene-methyl methacrylate copolymer, styrene-acrylonitrile-1,3-butadiene-itaconic acid copolymer, styrene-acrylonitrile-1,3-butadiene-methyl methacrylate-fumaric acid copolymer, styrene-1,3-butadiene-itaconic acid-methyl methacrylate-acrylonitrile copolymer, acrylonitrile-1,3-butadiene-methacrylic acid-methyl methacrylate copolymer, styrene-1,3-butadiene-itaconic acid-methyl methacrylate-acrylonitrile copolymer and styrene-acrylonitrile-1,3-butadiene-methyl methacrylate-fumaric acid copolymer; olefin polymers such as ethylene-propylene copolymer, ethylene-propylene-diene copolymer, polystyrene, polyethylene, polypropylene, ethylene-vinyl acetate copolymer, ethylene ionomer, polyvinyl alcohol, vinyl acetate polymer, ethylene-vinyl alcohol copolymer, chlorinated polyethylene, polyacrylonitrile, polyacrylic acid, polymethacrylic acid and chlorosulfonated polyethylene; styrene polymers such as styrene-ethylene-butadiene copolymer, styrene-butadiene-propylene copolymer, styrene-isoprene copolymer, styrene-n-butyl acrylate-itaconic acid-methyl methacrylate-acrylonitrile copolymer and styrene-n-butyl acrylate-itaconic acid-methyl methacrylate-acrylonitrile copolymer; acrylate polymers such as poly(methyl methacrylate), poly(methyl acrylate), poly(ethyl acrylate), poly(butyl acrylate), acrylate-acrylonitrile copolymer and 2-ethylhexyl acrylate-methyl acrylate-acrylic acid-methoxy polyethyleneglycol monomethacrylate; polyamide and polyimide polymers such as polyamide 6, polyamide 66, polyamide 11, polyamide 12, aromatic polyamide and polyimide; ester polymers such as polyethylene terephthalate and polybutylene terephthalate; cellulose polymers (including salts (ammonium salt, alkali-metal salt) thereof) such as carboxymethyl cellulose, carboxyethyl cellulose, ethyl cellulose, hydroxymethyl cellulose, hydroxypropyl cellulose and carboxyethylmethyl cellulose; block copolymers such as styrene-butadiene block copolymer, styrene-butadiene-styrene block copolymer, styrene-ethylene-butylene-styrene block copolymer, styrene-isoprene block copolymer and styrene-ethylene-propylene-styrene block copolymer; ethylene-vinyl chloride copolymer and ethylene-vinyl acetate copolymer; and others such as methyl methacrylate polymer.

### (Electrolyte)

Examples of the electrolyte to be used for a lithium ion secondary battery include non-aqueous electrolytes obtained by dissolving a lithium salt in an organic solvent. Examples of the lithium salt include one kind among LiClO₄, LiPF₆, LiAsF₆, LiSbF₆, LiBF₁, LiCF₃SO₃, LiN(SO₂CF₃)₂, LiC(SO₂CF₃)₃, lower aliphatic lithium carbonate and LiAlCl₄, and mixtures of two or more kinds thereof.

Among these, lithium salts containing at least one selected from the group consisting of LiPF₆, LiAsF₆, LiSbF₆, LiBF₄, LiCF₃SO₃, LiN (CF₃SO₂)₂, and LiC (CF₃SO₂)₃, respectively containing fluorine, are preferably used as the lithium salt.

As the organic solvent to be used in the above-mentioned electrolytes, it is possible to use, for example, carbonates such as propylene carbonate, ethylene carbonate, dimethyl carbonate, diethyl carbonate, ethylmethyl carbonate, 4-trifluoromethyl-1,3-dioxoran-2-one and 1,2-di(methoxycarbonyloxy) ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran and 2-methyltetrahydrofuran; esters such as methyl formate, methyl acetate and γ-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulfolane, dimethyl sulfoxide and 1,3-propanesultone; or the above-mentioned organic solvents having a fluorine substituent introduced therein, and a mixture of two or more thereof is usually used.

The shape of the battery of the present invention is not particularly limited and includes a laminate shape, a coin shape, a cylindrical shape, and a prismatic shape.

### EXAMPLES

Hereinafter, the present invention will be described by way of examples; however, the present invention is not limited to these examples.

The properties of separators were measured by the following methods in the following example, comparative example and reference example.

(1) Dimension retention: A separator was cut out into a piece 5-cm square, a marking line of 4-cm square was drawn in the center of the piece, and the piece was sandwiched between two sheets of paper and held for one hour in an oven at 150° C. The piece was then taken out and the dimension of the drawn square was measured to calculate dimension retention. A calculation method of the dimension retention is as follows.
Length of marking line in machine direction (MD) before heating: L1
Length of marking line in transverse direction (TD) before heating: W1
Length of marking line in machine direction (MD) after heating: L2
Length of marking line in transverse direction (TD) after heating: W2

Dimension retention in machine direction (MD) (%)=L2/L1×100

Dimension retention in transverse direction (TD) (%)=W2/W1×100

(2) Air permeability: in accordance with JIS P 8117

### Reference Example 1

### Polyethylene Porous Membrane

Ultra-high molecular weight polyethylene powder (70% by weight) (340M, produced by Mitsui Chemicals, Inc.) and 30% by weight of polyethylene wax (FNP-0115, produced by NIPPON SEIRO CO., LTD.) having a weight average molecular weight of 1000, and 0.4% by weight of an antioxidant (Irg 1010, produced by Ciba Specialty Chemicals), 0.1% by weight of an antioxidant (P168, produced by Ciba Specialty Chemicals) and 1.3% by weight of sodium stearate with respect to 100 parts by weight of the ultra-high molecular weight polyethylene and the polyethylene wax were added, and to the resulting mixture, calcium carbonate (produced by MARUO CALCIUM CO., LTD.) having an average particle size of 0.1 μm was added so as to be 38% by volume with respect to the whole volume of the mixture. These materials were mixed as powder by a Henschel mixer, and then melt-kneaded by a twin-screw kneader to obtain a polyolefin resin composition. The polyolefin resin composition was rolled with a pair of roller whose surface temperature was 150° C. to prepare a sheet. The sheet was immersed in an aqueous hydrochloride solution (hydrochloric acid 4 mole/L, nonionic surfactant 0.5% by weight) to remove calcium carbonate, subsequently stretched by 6 times at 105° C., and subjected to a corona treatment at 50 W/(m²/minute) to obtain a porous membrane film (thickness 16.6 μm) of polyolefin.

### Example 1

Alumina fine particles (100 parts by weight) (“AKP3000” (trade name) produced by Sumitomo Chemical Co., Ltd.), 3 parts by weight of an acetoacetyl-modified polyvinyl alcohol (produced by Nippon Synthetic Chemical Industry Co., Ltd., trade name: Z-410, degree of saponification 97.5 to 98.5% by mole), and 34 parts by weight of isopropyl alcohol were mixed, and to the resulting mixture, water was added so that a solid content was 23% by weight, and the resulting mixture was stirred and mixed by a planetary centrifugal mixer. The resulting mixture was stirred and mixed with a thin-film spin system high-speed mixer (FILMIX (registered trademark), manufactured by PRIMIX Corporation) to obtain a composition as a uniform slurry. The composition was uniformly applied to one side of the porous membrane film of polyolefin obtained in Reference Example 1 with a multi labo coater, and the applied composition was irradiated with ultraviolet rays in the condition of 180 mW/cm² for 10 minutes using a ultraviolet irradiation apparatus and then dried at 60° C. for 5 minutes in a drying machine to obtain a separator for a non-aqueous electrolyte secondary battery.

The obtained separator had a thickness of 28.1 μm and a weight per unit area of 18.7 g/m° (porous polyethylene film 7.6 g/m², acetoacetyl-modified polyvinyl alcohol 0.3 g/m², alumina: 10.8 g/m²). The properties of the separator are as follows.

(1) Dimension retention: 78% in machine direction (MD) and 83% in transverse direction (TD)
(2) Air permeability: 100 seconds/100 cc

### Reference Example 2

A separator for a non-aqueous electrolyte secondary battery was obtained in the same manner as in Example 1 except for not carrying out ultraviolet irradiation. The properties of the obtained separator are shown in Table 1.

### Comparative Example 1

A separator for a non-aqueous electrolyte secondary battery was obtained in the same manner as in Reference Example 2 except for using polyvinyl alcohol (produced by Wako Pure Chemical Industries, Ltd., Wako first class, average degree of polymerization 3100 to 3900, degree of saponification 86 to 90% by mole) in place of the acetoacetyl-modified polyvinyl alcohol. The properties of the obtained separator are shown in Table 1.

TABLE 1

| | | | Weight per unit | Air | Dimension retention | |
|---|---|---|---|---|---|---|
| | | UV | area of composition | permeability | Machine | Transverse |
| | Binder resin | irradiation | layer (g/m²) | (sec/100 cc) | direction (%) | direction (%) |
| Example 1 | Acetoacetyl- | Yes | 11.2 | 100 | 78 | 83 |
| Reference | modified | No | 11.7 | 97 | 68 | 73 |
| Example 2 | polyvinyl | | | | | |
| | alcohol | | | | | |
| Comparative | Polyvinyl | | 11.1 | 113 | 30 | 46 |
| Example 1 | alcohol | | | | | |

It can be said that when the separator has higher dimension retention, the separator has excellent heat resistance.

### INDUSTRIAL APPLICABILITY

In accordance with the production method of the present invention, a separator for a non-aqueous electrolyte secondary battery having excellent heat resistance can be produced. A non-aqueous electrolyte secondary battery comprising such a separator is excellent in safety.

1. A method for producing a separator for a non-aqueous electrolyte secondary battery, the method comprising the following steps (1) and (2).
(1) a step of applying a binder resin composition comprising a resin having a group represented by the following formula (I) and a solvent to a porous membrane of polyolefin; and
(2) a step of irradiating the applied composition with ultraviolet rays to form a composition layer. 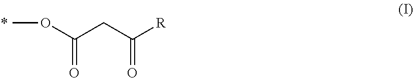
wherein R represents an alkyl group having 1 to 6 carbon atoms, and a symbol * represents a bonding hand.

2. The production method according to claim 1, wherein the binder resin composition in the step (1) further comprises filler particles.

3. The production method according to claim 2, wherein the filler particle are alumina particles.

4. The production method according to claim 1, wherein the resin having a group represented by the formula (I) is a resin having a structural unit represented by a formula (II). 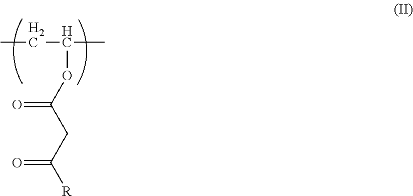
wherein R represents an alkyl group having 1 to 6 carbon atoms.

5. The production method according to claim 1, wherein the resin having a group represented by the formula (I) is a modified polyvinyl alcohol having a group represented by the formula (I).

6. The production method according to claim 1, further comprising:
(3) a step of drying the composition layer.

7. A separator for a non-aqueous electrolyte secondary battery obtained by the production method according to claim 1.

8. A non-aqueous electrolyte secondary battery comprising the separator according to claim 7.
